(19) United States
(12) Patent Application Publication
(10) Pub. No.: US 2009/0135148 A1
(43) Pub. Date: May 28, 2009

(54) PROXIMITY SENSING BY ACTIVELY DRIVING INTERESTED OBJECTS

(76) Inventor: Jared G. Bytheway, Sandy, UT (US)

Correspondence Address: MORRISS OBRYANT COMPAGNI, P.C., 734 EAST 200 SOUTH, SALT LAKE CITY, UT, 84102, US

(21) Appl. No.: 12/264,205

(22) Filed: Nov. 3, 2008

Related U.S. Application Data
(60) Provisional application No. 60/985,128, filed on Nov. 2, 2007.

(51) Int. Cl. G06F 3/041

(52) U.S. Cl. 345/173

(57) ABSTRACT

A touchpad that includes the ability to send a signal along an electrode to a user, wherein the user is then visible to the touchpad without having to touch the surface of the touchpad, and wherein different signals can be transmitted simultaneously to different users so that the different users are simultaneously visible and distinguishable to the proximity sensitive touchpad.

### CROSS REFERENCE TO RELATED APPLICATIONS

This document claims priority to and incorporates by reference all of the subject matter included in the provisional patent application docket number 4126.CIRQ.PR, having Ser. No. 60/985,128 and filed on Nov. 2, 2007.

### BACKGROUND OF THE INVENTION

1. Field of the Invention

This invention relates generally to touchpads. More specifically, the present invention is a system for performing proximity or far field sensing using a device that also includes the capability of operating as a touch sensitive device.

2. Description of Related Art

There are several designs for capacitance sensitive touchpads. One of the existing touchpad designs that can be modified to work with the present invention is a touchpad made by CIRQUE® Corporation. Accordingly, it is useful to examine the underlying technology to better understand how any capacitance sensitive touchpad can be modified to work with the present invention.

The CIRQUE™ Corporation touchpad is a mutual capacitance-sensing device and an example is illustrated as a block diagram in FIG. 1. In this touchpad 10, a grid of X (12) and Y (14) electrodes and a sense electrode 16 is used to define the touch-sensitive area 18 of the touchpad. Typically, the touchpad 10 is a rectangular grid of approximately 16 by 12 electrodes, or 8 by 6 electrodes when there are space constraints. Interlaced with these X (12) and Y (14) (or row and column) electrodes is a single sense electrode 16. All position measurements are made through the sense electrode 16.

The CIRQUE® Corporation touchpad 10 measures an imbalance in electrical charge on the sense line 16. When no pointing object is on or in proximity to the touchpad 10, the touchpad circuitry 20 is in a balanced state, and there is no charge imbalance on the sense line 16. When a pointing object creates imbalance because of capacitive coupling when the object approaches or touches a touch surface (the sensing area 18 of the touchpad 10), a change in capacitance occurs on the electrodes 12, 14. What is measured is the change in capacitance, but not the absolute capacitance value on the electrodes 12, 14. The touchpad 10 determines the change in capacitance by measuring the amount of charge that must be injected onto the sense line 16 to reestablish or regain balance of charge on the sense line.

The system above is utilized to determine the position of a finger on or in proximity to a touchpad 10 as follows. This example describes row electrodes 12, and is repeated in the same manner for the column electrodes 14. The values obtained from the row and column electrode measurements determine an intersection which is the centroid of the pointing object on or in proximity to the touchpad 10.

In the first step, a first set of row electrodes 12 are driven with a first signal from P, N generator 22, and a different but adjacent second set of row electrodes are driven with a second signal from the P, N generator. The touchpad circuitry 20 obtains a value from the sense line 16 using a mutual capacitance measuring device 26 that indicates which row electrode is closest to the pointing object. However, the touchpad circuitry 20 under the control of some microcontroller 28 cannot yet determine on which side of the row electrode the pointing object is located, nor can the touchpad circuitry 20 determine just how far the pointing object is located away from the electrode. Thus, the system shifts by one electrode the group of electrodes 12 to be driven. In other words, the electrode on one side of the group is added, while the electrode on the opposite side of the group is no longer driven. The new group is then driven by the P, N generator 22 and a second measurement of the sense line 16 is taken.

From these two measurements, it is possible to determine on which side of the row electrode the pointing object is located, and how far away. Pointing object position determination is then performed by using an equation that compares the magnitude of the two signals measured.

The sensitivity or resolution of the CIRQUE® Corporation touchpad is much higher than the 16 by 12 grid of row and column electrodes implies. The resolution is typically on the order of 960 counts per inch, or greater. The exact resolution is determined by the sensitivity of the components, the spacing between the electrodes 12, 14 on the same rows and columns, and other factors that are not material to the present invention.

The process above is repeated for the Y or column electrodes 14 using a P, N generator 24

Although the CIRQUE® touchpad described above uses a grid of X and Y electrodes 12, 14 and a separate and single sense electrode 16, the sense electrode can actually be the X or Y electrodes 12, 14 by using multiplexing. Either design will enable the present invention to function.

### BRIEF SUMMARY OF THE INVENTION

In a preferred embodiment, the present invention is a touchpad that includes the ability to send a signal along an electrode to a user, wherein the user is then visible to the touchpad without having to touch the surface of the touchpad, and wherein different signals can be transmitted simultaneously to different users so that the different users are simultaneously visible and distinguishable to the proximity sensitive touchpad.

These and other objects, features, advantages and alternative aspects of the present invention will become apparent to those skilled in the art from a consideration of the following detailed description taken in combination with the accompanying drawings.

### BRIEF DESCRIPTION OF THE SEVERAL VIEWS OF THE DRAWINGS

FIG. 1 is a block diagram of a touchpad that is found in the prior art, and which is adaptable for use in the present invention.

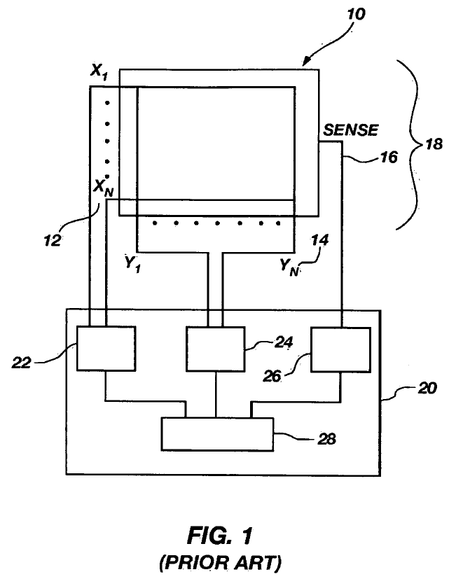

FIG. 2 is a perspective view of a chair coupled to a touchpad.

FIG. 3 is a display from an oscilloscope showing an unoccupied chair that has an electrode couple to the chair that has a signal being transmitted thereon.

FIG. 4 is a display from the oscilloscope with a person sitting in the chair but not within range of a near a proximity sensitive touchpad.

FIG. 5 is a display from the oscilloscope with a person sitting in the chair but with a finger that is now within range of the proximity sensitive touchpad.

FIG. 6 is a display from the oscilloscope with a person sitting in the chair but with a finger that is nearer to the proximity sensitive touchpad than in FIG. 5.

FIG. 7 is a display from the oscilloscope with a person standing next to the chair but no longer having a signal coupled to them.

### DETAILED DESCRIPTION OF THE INVENTION

Reference will now be made to the drawings in which the various elements of the present invention will be given numerical designations and in which the invention will be discussed so as to enable one skilled in the art to make and use the invention. It is to be understood that the following description is only exemplary of the principles of the present invention, and should not be viewed as narrowing the claims which follow.

A first embodiment of the invention is a proximity or proximity and touch-sensitive touchpad that is capable of distinguishing between different signals being transmitted by detectable objects. Thus, the circuitry associated with the touchpad is capable of not only detecting objects, but also detecting the signals that are being transmitted by the objects.

The signal that is being transmitted by the detectable objects can be generated by the touchpad itself, or by another object. What is important is that different signals be detectable. For example, there are various electrodes in the sensor grid of the touchpad. A signal can be generated on any of the electrodes, and then this signal can be placed on a wire which is then coupled to an object either directly or capacitively.

The signal that is directly or capacitively coupled to an object makes the object detectable to the touchpad before the user makes contact with a touchpad surface. It is understood that proximity sensitive touchpads already exist. However, these proximity sensitive touchpads are simply detecting objects that have no special characteristics. In other words, the sensitivity of the touchpad circuitry itself is being increased without changing the nature of the object being detected. In contrast, the first embodiment of the present invention changes the nature of the object being detected by coupling a signal to the object so that it is more detectable.

An object that is more detectable is defined as an object that is detectable at a greater distance than if the object did not have a signal coupled to it, or it is an object that generates a signal that is easier to detect for a given distance. In other words, the object creates a larger signature at a given distance when a signal is coupled to the object in contrast to the signature generated at that same distance when there is no signal coupled to it.

Having explained that the touchpad can detect a signal, it should be understood that different signals can be coupled to different objects at the same time. These different objects are then not only detectable, but the touchpad can also distinguish between the different objects.

The signals that are being coupled directly or capacitively to the objects can be waveforms or DC offsets. The waveforms can be of any type, including but not limited to sine waves, square waves, etc. The characteristics of the waveforms can be varied and detected by the touchpad. Thus, the shape of two waveforms might be identical but vary in some other aspect such as frequency or voltage. In a different embodiment, one waveform might be a sine wave and another can be a square wave. Thus, the touchpad is capable of detecting any difference in the waveforms that can be imposed on them.

The distances described hereinafter are examples only, and can be increased with a system that is further adapted specifically for proximity sensing. Thus, the claims are not limited to the specific distances described herein.

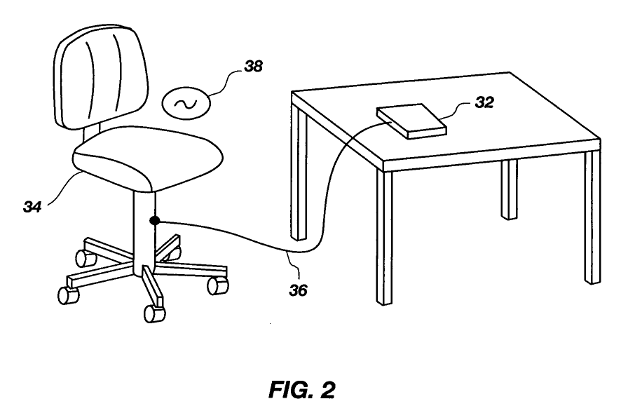

FIG. 2 is a perspective diagram that illustrates the configuration of objects being used to generate the detected signal being monitored on a sense line of a touchpad. FIG. 2 shows the touchpad 32 and an unoccupied chair 34 that is coupled to an electrode 36 coming from the touchpad. A driven signal 38 is being generated by the touchpad 32 on the electrode 36 and transmitted to the chair 34. The chair 34 is far enough away from the touchpad 32 such that the driven signal 38 coupled to the chair 34 is not yet detectable by the touchpad. At this time, the chair is radiating the driven signal 38 transmitted from the touchpad 32 through electrode 36.

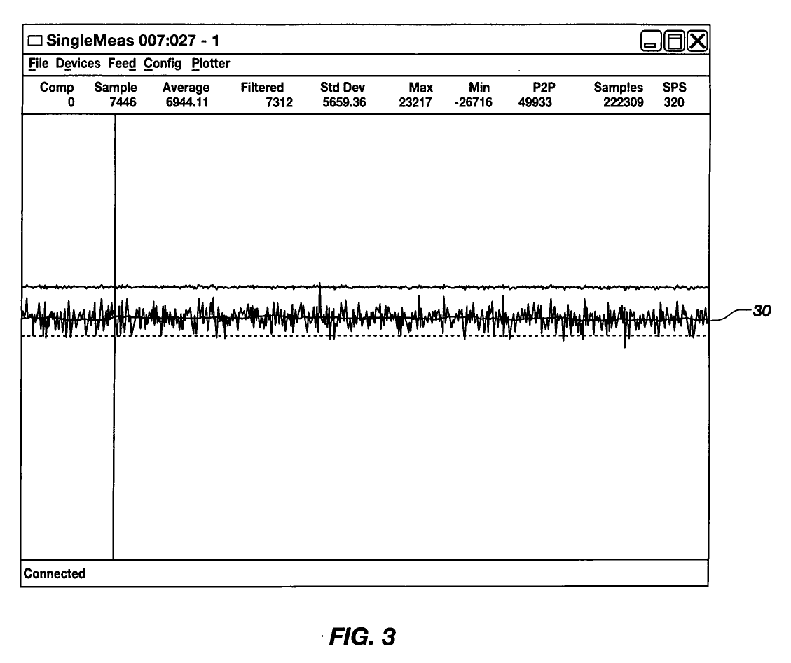

FIG. 3 is a display from an oscilloscope showing no object being detected by the sense line of the touchpad 32 of the present invention. Accordingly, the signal level of signal 10 would be considered a baseline if loading did not drop the signal level. The chair 34 is unoccupied at this time.

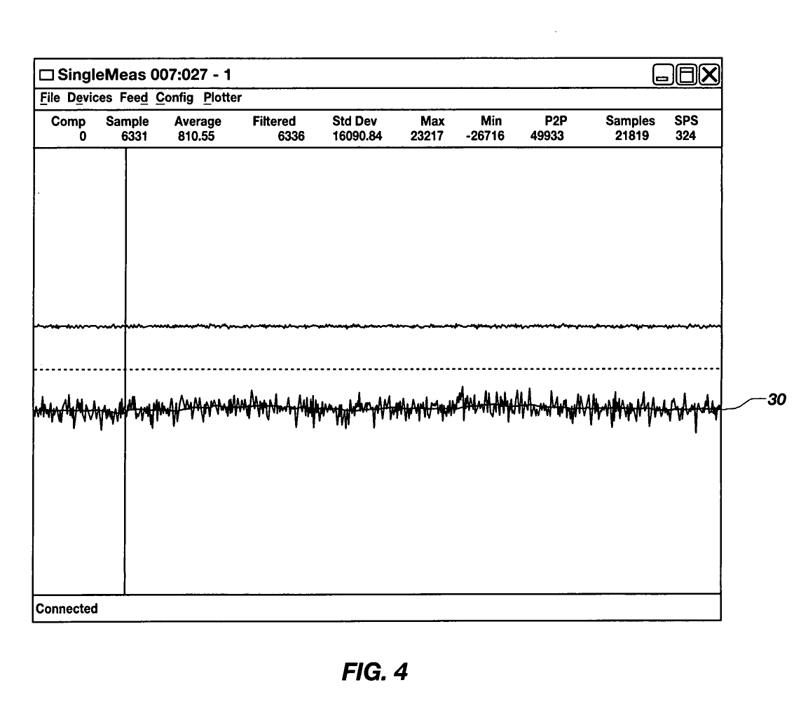

FIG. 4 is a display from the oscilloscope with a person sitting in the chair but still not within detectable range of the touchpad 32. The distance of the person (whose hand is the object that is going to be detected) is approximately 25 cm to the touchpad 32. The distance is for illustration purposes only and should not be considered to be limiting on the scope of the invention or the capabilities of the invention.

It is noted that the driven signal 38 being coupled to the person is 3.5 volts for illustration purposes only. The electrode 36 is coupled to a center post of the chair 34. The center post is made of metal, and is electrically coupled to a metal plate on the bottom of the seat and is approximately 15 cm by 35 cm. The metal plate is also electrically coupled to two metal poles in the seat back cushion. The driven signal 38 from the touchpad 32 is thus being capacitively coupled to the person in the chair 34.

Note that the signal 30 on the touchpad sense line has decreased from the level shown in FIG. 3. This decrease is due to loading of the sense line by the presence of the person sitting in the chair 34. The loading caused by the presence of the person can be compensated for so that it does not affect the sense line, but is shown herein for illustration purposes only. This signal 30 on the sense line can be considered the baseline for the remaining figures.

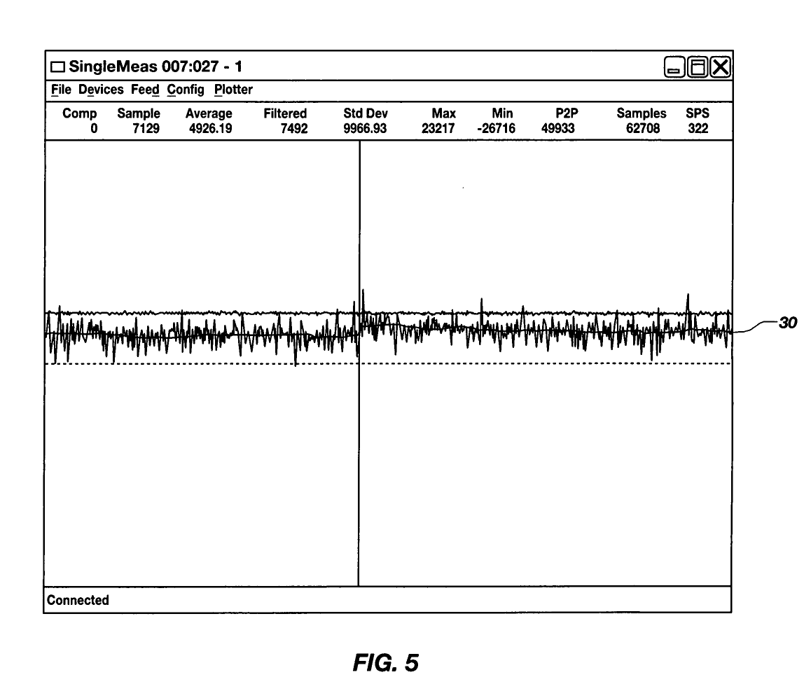

FIG. 5 is a display from the oscilloscope with a person sitting in the chair 34 but with a finger that is now within detection range of the touchpad 32. A fingertip of the person's hand is now approximately 10 cm from the touchpad 32. This distance is not limiting and is for illustration purposes only.

The signal 30 on the touchpad sense line has increased from the level shown in FIG. 4. This increase is due to the fact that the touchpad 32 has detected the approaching object.

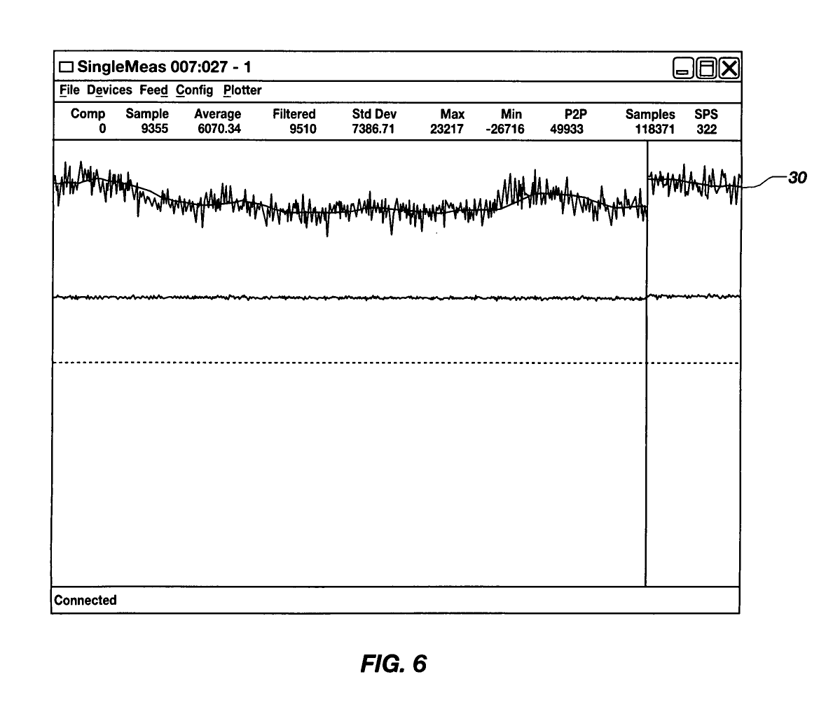

FIG. 6 is a display from the oscilloscope with a person sitting in the chair 34 but with a finger that is nearer to the touchpad 32 than in FIG. 5. The fingertip is now approximately 3 cm from the touchpad 32. The detected signal 30 on the sense line has increased substantially in amplitude.

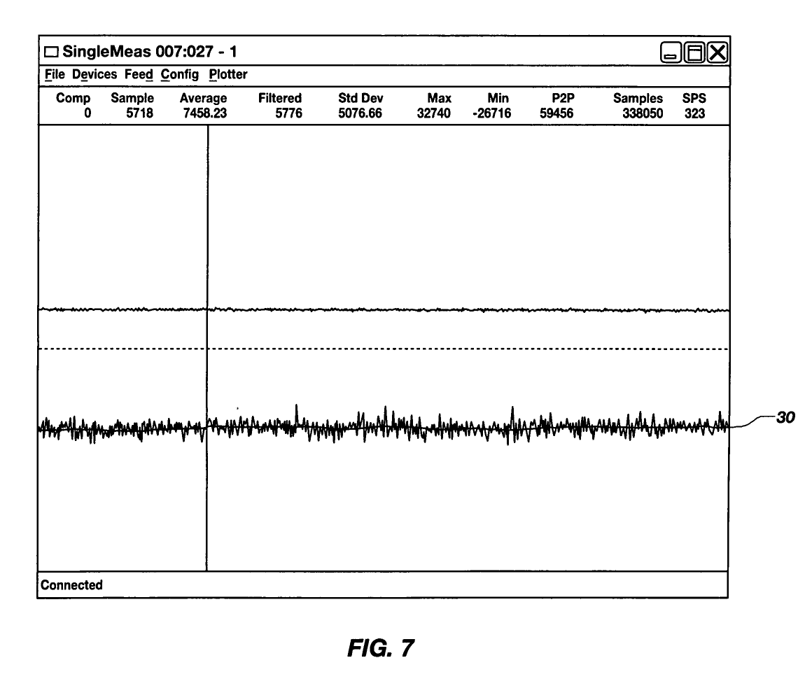

FIG. 7 is a display from the oscilloscope with a person standing next to the chair and not touching it so that there is no capacitive coupling. The drive signal 38 is thus no longer coupled to the person. However, the person's finger is still 3 cm away from the touchpad 32. The person is no longer of interest to the touchpad 32. The person is probably still detectable as any object that is no longer radiating a driven signal 38. However, the distance at which the person is detectable is now significantly reduced without the presence of the driven signal 38 being coupled to the person.

When the person is no longer coupled to the driven signal 38, the person “loads” the sense line which reduces the ambient coupling of the electrode. Accordingly, the signal 10 on the sense line has now decreased.

The touchpad of this first embodiment can be designed such that signals from all other objects are rejected if the objects are not radiating the driven signal 38 that the system is programmed to detect. The system is thus versatile because it can be programmed to detect any driven signal 38 that can be produced.

In another embodiment, multiple objects can also be uniquely detected by driving each object with a unique signal. In the first embodiment, the touchpad drives each electrode with a unique signal. Thus for two objects, two electrodes are used. Alternatively, a single electrode can be used by multiplexing different driven signals onto multiple objects, but at different time intervals. A switching mechanism must be used to ensure that each object receives a unique driven signal.

While the touchpad 32 of the first embodiment uses a wire or trace as the sense line, the sense line can also be implemented as a plate or other object capable of detecting and transmitting the detected driven signal 38 to touchpad sensor circuitry that interprets the signals being detected.

A particularly useful application of the present invention is the ability to easily distinguish between different people who might both use a particular input device. For example, consider the occupants of a vehicle. More specifically, consider a driver and a front seat passenger. The functionality of a common control panel can be altered depending on the identity of the person approaching the control panel with a hand or finger.

Functionality of non-critical automotive controls can be altered depending on whether the driver or the front seat passenger is trying to access the controls. Wire mesh embedded in the driver and passenger seats can be connected to two different electrodes or a single multiplexed electrode that generates a unique drive signal for the driver and passenger. The unique drive signals are capacitively coupled to the occupant of a seat in the front of the vehicle. The seat occupants radiate a unique signal that is detectable by a touchpad in the common control panel.

A sense electrode, panel or metallic mesh mounted in the common control panel can detect whether the driver or passenger is trying to access the controls. Certain functions can be disabled for the driver if the car is moving to reduce distractions for the driver while the vehicle is moving. Thus, a different set of controls can be made to appear depending upon the identity of the person whose finger is approaching the common control panel. For example, the driver might have a master control be displayed that includes several desired functions. However, certain functions might not appear if the controls require too much attention from the driver. In contrast, these functions that require more attention might appear for the front seat passenger while the vehicle is in motion. Some functions might be exclusive to the driver or passenger. For example, seat configuration controls will only adjust the seat of the person touching the common control panel.

Another aspect of the present invention is that the touchpad continues to function as a touch sensitive device.

Sensitivity of the present invention can be increased by increasing the amplitude of the drive signal. Whereas the system shown in the figures is operating at a drive signal level of 3.5 volts, the amplitude of the drive signal can be increased, thereby resulting increased sensitivity of the system. Increased sensitivity of the system will result in an object coupled to a drive signal to be detectable at a distance that is further away than if the drive signal was at a lower voltage. For example, the system operates effectively using a drive signal of 12 volts.

It is to be understood that the above-described arrangements are only illustrative of the application of the principles of the present invention. Numerous modifications and alternative arrangements may be devised by those skilled in the art without departing from the spirit and scope of the present invention. The appended claims are intended to cover such modifications and arrangements.

What is claimed is:

1. A method for actively coupling a signal to objects that are detectable by a touchpad to thereby increase detection distance, said method comprising the steps of:
1) providing a touchpad having a sense line for detecting signals, and wherein a first electrode from the touchpad is coupled to a first object;
2) transmitting a first drive signal on the first electrode to the first object; and
3) detecting the first drive signal radiated by the first object on the sense line of the touchpad.

2. The method as defined in claim 1 wherein the step of coupling the first electrode to the first object further comprises the step of capacitively coupling the first electrode to the first object.

3. The method as defined in claim 1 wherein the step of coupling the first electrode to the first object further comprises the step of directly coupling the first electrode to the first object.

4. The method as defined in claim 1 wherein the method further comprises the steps of:
1) providing a second electrode that is coupled to a second object;
2) transmitting a second drive signal to the second object that is different from the first drive signal; and
3) detecting the second drive signal radiated by the second object on the sense line of the touchpad.

5. The method as defined in claim 1 wherein the method further comprises the step of:
1) multiplexing the first electrode such that the first electrode is coupled for a first period of time to the first object, and coupled for a second period of time to a second object;
2) transmitting a second drive signal to the second object that is different from the first drive signal; and
3) detecting the second drive signal radiated by the second object on the sense line of the touchpad.

6. The method as defined in claim 1 wherein the method further comprises the step of providing a drive signal that is selected from the group of drive signals comprised of sinusoidal waveforms and DC offsets.
